(19) United States
(12) Patent Application Publication
(10) Pub. No.: US 2012/0327215 A1
(43) Pub. Date: Dec. 27, 2012

(54) HIGH SPEED OPTICAL SENSOR INSPECTION SYSTEM

(76) Inventors: Steven K. Case, St. Louis Park, MN (US); Beverly Caruso, St. Louis Park, MN (US); Todd D. Liberty, Apple Valley, MN (US); Timothy A. Skunes, Mahtomedi, MN (US); Carl E. Haugan, St. Paul, MN (US); Chuanqi Chen, Singapore (SG); Hiroshi Anzai, Kanagawa (JP)

(21) Appl. No.: 13/480,079

(22) Filed: May 24, 2012

Related U.S. Application Data
(63) Continuation-in-part of application No. 12/940,214, filed on Nov. 5, 2010.
Application No. 12/940,214 is a continuation-in-part of application No. 12/886,803, filed on Sep. 21, 2010.
(60) Provisional application No. 61/492,093, filed on Jun. 1, 2011.
(60) Provisional application No. 61/244,616, filed on Sep. 22, 2009.
(60) Provisional application No. 61/244,671, filed on Sep. 22, 2009.

(51) Int. Cl. H04N 7/18; G06F 17/00

(52) U.S. Cl. 348/92; 235/375; 348/E07.085

(57) ABSTRACT

An optical inspection sensor is provided. The sensor includes an array of cameras configured to acquire image data relative to a workpiece that moves relative to the array of cameras in a non-stop fashion. An illumination system is disposed to provide a pulse of illumination when the array of cameras acquires the image data. At least some image data includes data regarding a skip mark or barcode on the workpiece.

### CROSS-REFERENCE TO RELATED APPLICATION

The present application claims is based on and claims the benefit of U.S. Provisional Application Ser. No. 61/492,093 filed Jun. 1, 2011; and the present application is a Continuation-In-Part application of U.S. patent application Ser. No. 12/940,214, filed Nov. 5, 2010, which application is a Continuation-In-Part application of U.S. patent application Ser. No. 12/886,803, filed Sep. 21, 2010, which application is based on and claims the benefit of U.S. Provisional Application Ser. No. 61/244,616, filed Sep. 22, 2009 and U.S. Provisional Application Ser. No. 61/244,671, filed on Sep. 22, 2009.

### COPYRIGHT RESERVATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Automated electronics assembly machines are often used in the manufacture of printed circuit boards, which are used in various electronic devices. The manufacturing process is generally required to operate quite swiftly. Rapid or high speed manufacturing ensures that costs of the completed printed circuit board are minimized. However, the speed with which printed circuit boards are manufactured must be balanced by the acceptable level of scrap or defects caused by the process. Printed circuit boards can be extremely complicated and small and any one board may have a vast number of components and consequently a vast number of electrical connections. Printed circuit boards are now produced in large quantities. Since such printed circuit boards can be quite expensive and/or be used in expensive equipment, it is important that they be produced accurately and with high quality, high reliability, and minimum scrap. Unfortunately, because of the manufacturing methods available, some level of scrap and rejects still occurs. Typical faults on printed circuit boards include inaccuracy of placement of components on the board, which might mean that the components are not correctly electrically connected in the board. Another typical fault occurs when an incorrect component is placed at a given location on a circuit board. Additionally, the component might simply be absent, or it may be placed with incorrect electrical polarity. Further still, if there are insufficient solder paste deposits, this can lead to poor connections. Additionally, if there is too much solder paste, such a condition can lead to short circuits, and so on. Further still, other errors may prohibit, or otherwise inhibit, electrical connections between one or more components, and the board. An example of this condition is when a small, “stray” electrical component is accidentally released onto a section of the circuit board where another component is to be subsequently placed by another placement operation. This stray component may prevent electrical connectivity of the “correct” component that is placed onto the printed circuit board after the stray component. The condition if further exacerbated when the correct component has a package style, such as a ball grid array (BGA) or flip chip, where the electrical connections are visibly hidden after placement. In this condition, the stray component and the integrity of the solder joints cannot be visibly inspected either manually or by automated optical inspection (AOI) systems for errors or defects since the defects are hidden by the component package. X-ray systems may detect these errors, but these systems remain too slow and expensive for wide spread adoption in most printed circuit board assembly lines.

Conventional automated optical inspection systems receive a substrate, such as a printed circuit board, either immediately after placement of the components upon the printed circuit board and before wave soldering, or post reflow. Typically, the systems include a conveyor that is adapted to move the substrate under test through an optical field of view that acquires one or more images and analyzes those images to automatically derive conclusions about components on the substrate and/or the substrate itself. The amount of time to initially program the inspection inputs is often high for these systems and also to fine tune the inspection parameters or models. Another drawback to these automated optical inspection systems is that, although they can identify manufacturing errors, they often provide little help to identify the particular processes that caused the manufacturing error. As such, a need has arisen to provide an improved inspection system that simplifies the initial inspection programming as well as providing additional insight into the root cause of manufacturing errors.

### SUMMARY

An optical inspection sensor is provided. The sensor includes an array of cameras configured to acquire image data relative to a workpiece that moves relative to array of cameras in a non-stop fashion. An illumination system is disposed to provide a pulse of illumination when the array of cameras acquires the image data. At least some image data includes data regarding a skip mark or barcode on the workpiece.

### BRIEF DESCRIPTION OF THE DRAWINGS

FIG. 1 is an elevation view of an automated high speed optical inspection system with a camera array and compact, integrated illuminator in accordance with an embodiment of the present invention.

FIG. 2 is a diagrammatic elevation view of a plurality of cameras having overlapping fields of view in accordance with an embodiment of the present invention.

FIG. 3 is a system block diagram of an inspection system in accordance with an embodiment of the present invention.

FIG. 4 is a top plan view of a transport conveyor, printed circuit board, and a camera array field of view acquired with a first illumination field type.

FIG. 5 is a top plan view of a transport conveyor, printed circuit board, and a camera array field of view acquired with a second illumination field type.

FIGS. 6A-6D illustrate a workpiece and camera array fields of view acquired at different positions and under alternating first and second illumination field types in accordance with an embodiment of the present invention.

FIG. 7 is a block diagram of an exemplary printed circuit board assembly line that includes an inspection system in accordance with an embodiment of the present invention.

FIG. 8 is a front elevation view of a portion of an assembly line.

FIG. 9A is a diagrammatic view of exemplary solder paste deposits identified by an inspection program in accordance with an embodiment of the present invention.

FIG. 9B is a diagrammatic view of an exemplary image of the same region depicted in FIG. 9A captured with an optical inspection sensor after an assembly operation in accordance with an embodiment of the present invention.

FIG. 9C is a diagrammatic view of a difference image between FIGS. 9A and 9B.

FIG. 10A is a diagrammatic view of an exemplary image acquired by an optical inspection system in accordance with an embodiment of the present invention.

FIG. 10B is a diagrammatic view of an exemplary image acquired by an optical inspection sensor where a stray component has been placed.

FIG. 10C is a diagrammatic difference image between FIGS. 10A and 10B.

### DETAILED DESCRIPTION OF ILLUSTRATIVE EMBODIMENTS

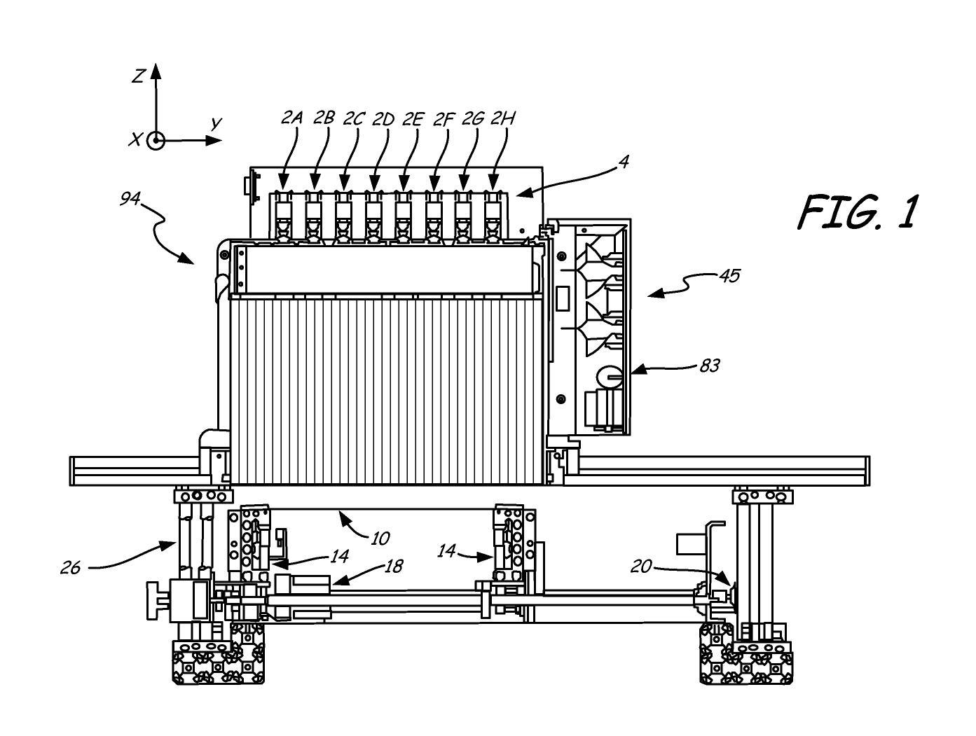

FIG. 1 shows an elevation view of a system for generating high contrast, high speed digital images of a workpiece that are suitable for automated inspection, in accordance with an embodiment of the present invention. Camera array 4 consists of cameras 2A through 2H preferably arranged at regular intervals. Each camera 2A through 2H simultaneously images and digitizes a rectangular area on a workpiece or substrate, such as printed circuit board 10, while the workpiece undergoes relative movement with respect to cameras 2A through 2H. Illuminator 45 provides a series of pulsed, short duration illumination fields referred to as strobed illumination. The short duration of each illumination field effectively “freezes” the image of printed circuit board 10 to suppress motion blurring. Two or more sets of images for each location on printed circuit board 10 are generated by camera array 4 with different illumination field types for each exposure. Depending on the particular features on printed circuit 10 board that need to be inspected, the inspection results may be appreciably enhanced by joint processing of the reflectance images generated with different illumination field types. The different illumination field types may include cloudy day, brightfield, or darkfield, for example.

Workpiece transport conveyor 26 translates printed circuit board 10 in the X direction in a nonstop mode to provide high speed imaging of printed circuit board 10 by camera array 4. Conveyor 26 includes belts 14 which are driven by motor 18. Optional encoder 20 measures the position of the shaft of motor 18 hence the approximate distance traveled by printed circuit board 10 can be calculated. Other methods of measuring and encoding the distance traveled of printed circuit board 10 include time-based, acoustic or vision-based encoding methods. By using strobed illumination and not bringing printed circuit board 10 to a stop, the time-consuming transport steps of accelerating, decelerating, and settling prior to imaging by camera array 4 are eliminated. It is believed that the time required to entirely image a printed circuit board 10 of dimensions 210 mm×310 mm can be reduced from 11 seconds to 4 seconds using embodiments of the present invention compared to coming to a complete stop before imaging.

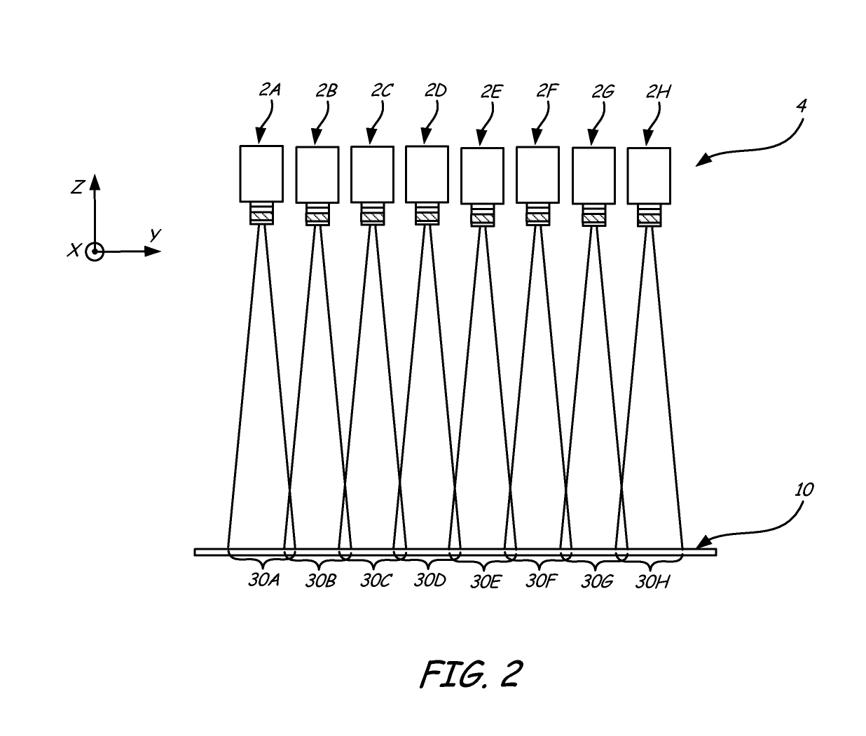

FIG. 2 shows the Y dimension location of each field of view 30A through 30H on printed circuit board 10 that is imaged by cameras 2A through 2H, respectively. There is a slight overlap between adjacent fields of view in order to completely image all locations on printed circuit board 10. During the inspection process, the images of discrete fields of view 30A through 30H are digitally merged, or stitched, into one continuous image in the overlap regions. Example camera array 4 is shown in FIGS. 1 and 2 arranged as a single dimensional array of discrete cameras. As shown, cameras 2A-2H are configured to image in a non-telecentric manner. This has the advantage that the fields of view 30A through 30H can be overlapped. However, the magnification, or effective resolution, of a non-telecentric imaging system will change as printed circuit 10 and its features are positioned closer or further away from cameras 2A-2H. Effects of circuit board 10 warpage, thickness variations and other camera alignment errors can be compensated by image stitching. In another embodiment, the camera array may be arranged in a two dimensional array. For example, the discrete cameras may be arranged into a camera array of two columns of four cameras where adjacent fields of view overlap. Other arrangements of the camera array may be advantageous depending on cost, speed, and performance goals of the inspection system, including arrays where the fields of view do not overlap. For example, a staggered array of cameras with telecentric imaging systems may be used.

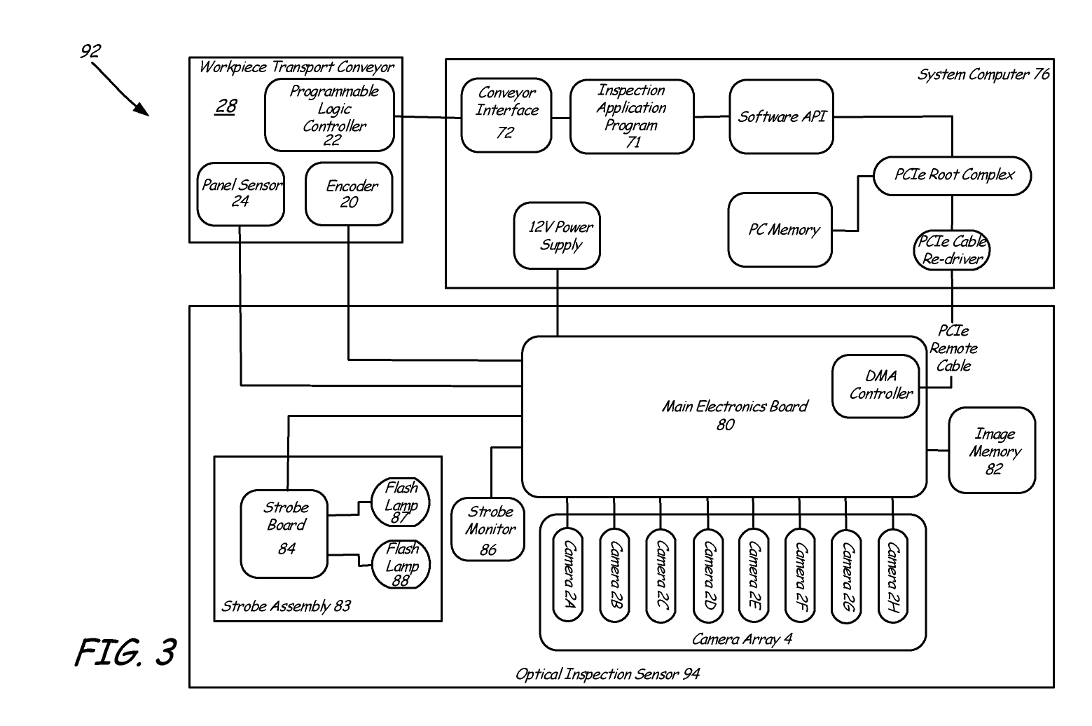

FIG. 3 is a block diagram of inspection system 92. Inspection application program 71 preferably executes on system computer 76. Inputs into inspection program 71 include the type of printed circuit board 10, CAD information describing the location and types of components on printed circuit board 10, the features on printed circuit board 10 to be inspected, lighting and camera calibration data, the transport conveyor 26 direction, et cetera. Inspection program 71 configures programmable logic controller 22 via conveyor interface 72 with the transport direction, velocity, and width of printed circuit board 10. Inspection program 71 also configures main electronics board 80 via PCI express interface with the number of encoder 20 counts between each subsequent image acquisition of camera array 4. Alternatively, a time-based image acquisition sequence may be executed based on the known velocity of printed circuit board 10. Inspection program 71 also programs or otherwise sets appropriate configuration parameters into cameras 2A-2H prior to an inspection as well as strobe board 84 with the individual flash lamp output levels.

Panel sensor 24 senses the edge of printed circuit board 10 as it is loaded into inspection system 92 and this signal is sent to main board 80 to begin an image acquisition sequence. Main board 80 generates the appropriate signals to begin each image exposure by camera array 4 and commands strobe board 84 to energize the appropriate flash lamps 87 and 88 at the proper time. Strobe monitor 86 senses a portion of light emitted by flash lamps 87 and 88 and this data may be used by main electronics board 80 to compensate image data for slight flash lamp output variations. Image memory 82 is provided and preferably contains enough capacity to store all images generated for at least one printed circuit board 10. For example, in one embodiment, each camera in the array of cameras has a resolution of about 5 megapixels and memory 82 has a capacity of about 2.0 gigabytes. Image data from cameras 2A-2H may be transferred at high speed into image memory buffer 82 to allow each camera to be quickly prepared for subsequent exposures. This allows the printed circuit board 10 to be transported through inspection system 92 in a nonstop manner and generate images of each location on printed circuit board 10 with at least two different illumination field types. The image data may begin to be read out of image memory into PC memory over a high speed electrical interface such as PCI Express (PCIe) as soon as the first images are transferred to memory 82. Similarly, inspection program 71 may begin to compute inspection results as soon as image data is available in PC memory.

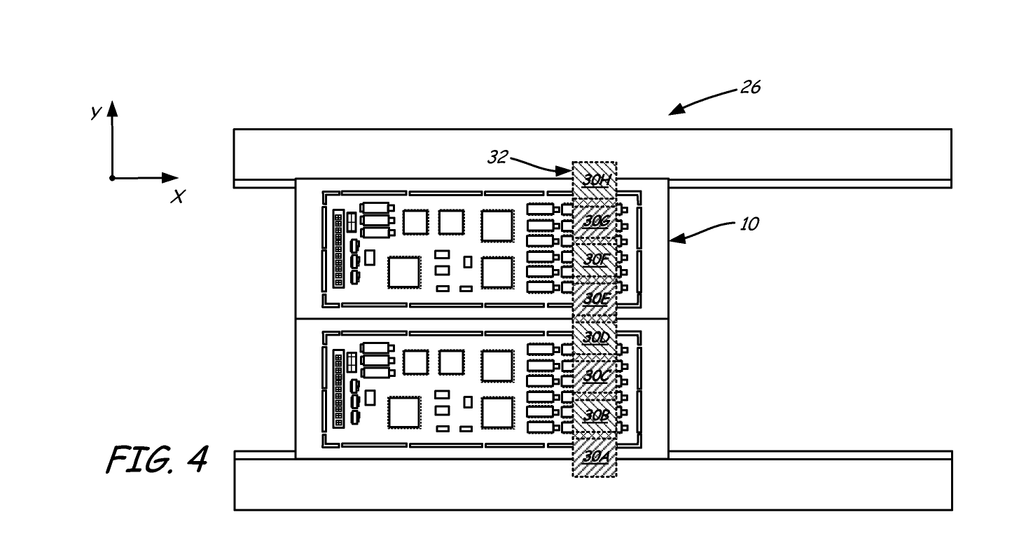

The image acquisition process will now be described in further detail with respect to FIGS. 4-6.

FIG. 4 shows a top plan view of transport conveyor 26 and printed circuit board 10. Cameras 2A-2H image overlapping fields of view 30A-30H, respectively, to generate effective field of view 32 of camera array 4. Field of view 32 is acquired with a first strobed illumination field type. Printed circuit board 10 is transported by conveyor 26 in a nonstop manner in the X direction. Printed circuit board 10 preferably travels at a velocity that varies less than five percent during the image acquisition process, although larger velocity variations and accelerations may be accommodated.

In one preferred embodiment, each field of view 30A-30H has approximately 5 million pixels with a pixel resolution of 17 microns and an extent of 33 mm in the X direction and 44 mm in the Y direction. Each field of view 30A-30H overlaps neighboring fields of view by approximately 4 mm in the Y direction so that center-to-center spacing for each camera 2A-2H is 40 mm in the Y direction. In this embodiment, camera array field of view 32 has a large aspect ratio in the Y direction compared to the X direction of approximately 10:1.

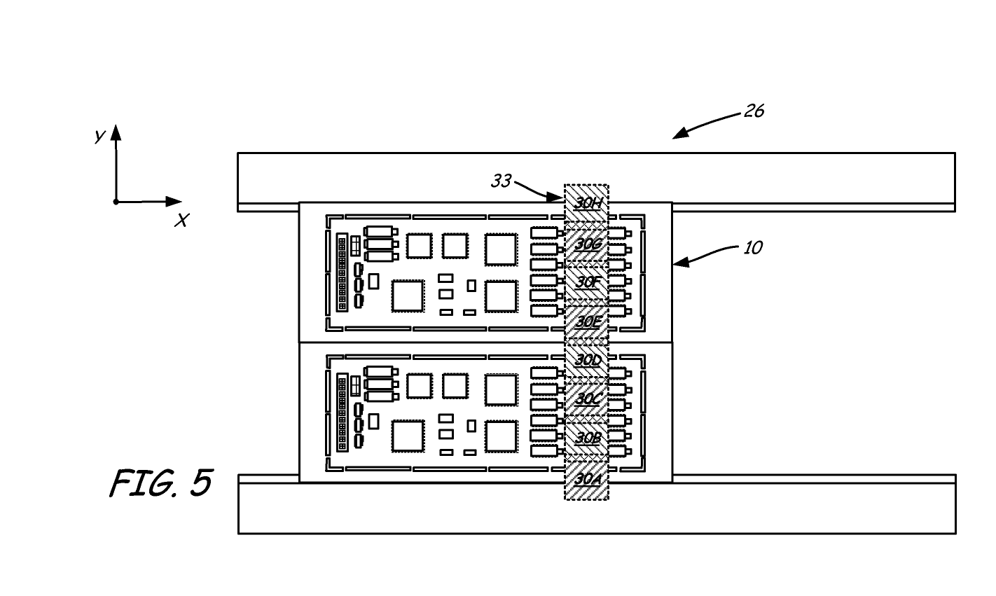

FIG. 5 shows printed circuit board 10 at a location displaced in the positive X direction from its location in FIG. 4. For example, printed circuit board may be advanced approximately 14 mm from its location in FIG. 4. Effective field of view 33 is composed of overlapping fields of view 30A-30H and is acquired with a second illumination field type.

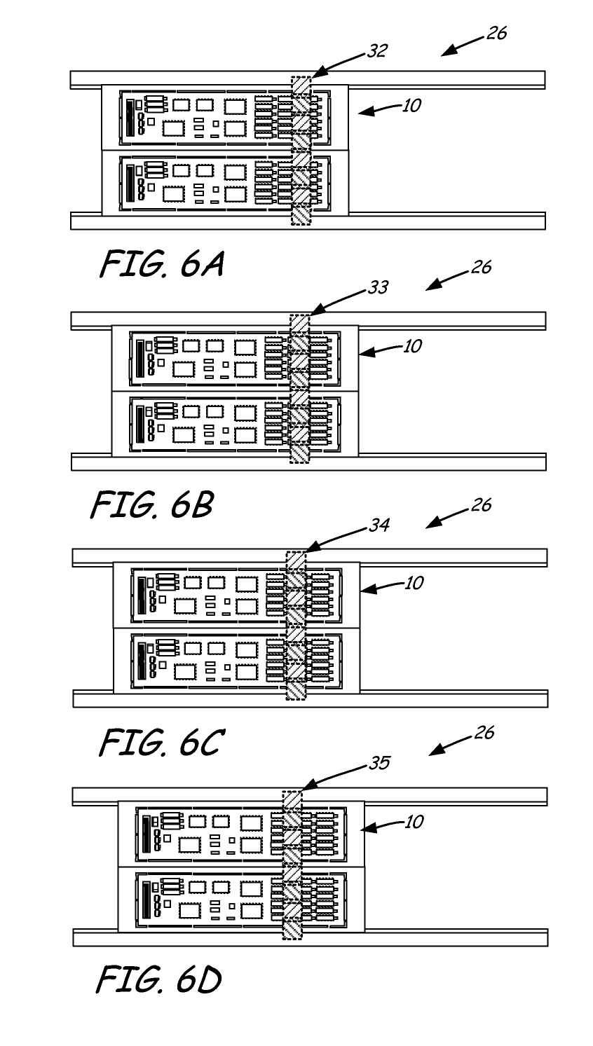

FIGS. 6A-6D show a time sequence of camera array fields of view 32-35 acquired with alternating first and second illumination field types. It is understood that printed circuit board 10 is traveling in the X direction in a nonstop fashion. FIG. 6A shows printed circuit board 10 at one X location during image acquisition for the entire printed circuit board 10. Field of view 32 is acquired with a first strobed illumination field type as discussed with respect to FIG. 4. FIG. 6B shows printed circuit board 10 displaced further in the X direction and field of view acquired with a second strobed illumination field type as discussed with respect to FIG. 5. FIG. 6C shows printed circuit board 10 displaced further in the X direction and field of view 34 acquired with the first illumination field type and FIG. 6D shows printed circuit board 10 displaced further in the X direction and field of view 35 acquired with the second illumination field type.

There is a small overlap in the X dimension between field of views 32 and 34 in order to have enough overlapping image information in order to register and digitally merge, or stitch together, the images that were acquired with the first illumination field type. There is also small overlap in the X dimension between field of views 33 and 35 in order to have enough overlapping image information in order to register and digitally merge the images that were acquired with the second illumination field type. In the embodiment with fields of view 30A-30H having extents of 33 mm in the X direction, it has been found that an approximate 5 mm overlap in the X direction between field of views acquired with the same illumination field type is effective. Further, an approximate 14 mm displacement in the X direction between fields of view acquired with different illumination types is preferred.

Images of each feature on printed circuit board 10 may be acquired with more than two illumination field types by increasing the number of fields of view collected and ensuring sufficient image overlap in order to register and digitally merge, or stitch together, images generated with like illumination field types. Finally, the stitched images generated for each illumination type may be registered with respect to each other. In a preferred embodiment, workpiece transport conveyor 26 has lower positional accuracy than the inspection requirements in order to reduce system cost. For example, encoder 20 may have a resolution of 100 microns and conveyor 26 may have positional accuracy of 0.5 mm or more. Image stitching of fields of view in the X direction compensates for positional errors of the circuit board 10.

The image contrast of various object features vary depending on several factors including the feature geometry, color, reflectance properties, and the angular spectrum of illumination incident on each feature. Since each camera array field of view may contain a wide variety of features with different illumination requirements, embodiments of the present invention address this challenge by imaging each feature and location on workpiece 10 two or more times, with each of these images captured under different illumination conditions and then stored into a digital memory. In general, the inspection performance may be improved by using object feature data from two or more images acquired with different illumination field types.

It should be understood that embodiments of the present invention are not limited to two lighting types such as dark field and cloudy day illumination field nor are they limited to the specific illuminator configurations. The light sources may project directly onto workpiece 10. The light sources may also have different wavelengths, or colors, and be located at different angles with respect to workpiece 10. The light sources may be positioned at various azimuthal angles around workpiece 10 to provide illumination from different quadrants. The light sources may be a multitude of high power LEDs that emit light pulses with enough energy to “freeze” the motion of workpiece 10 and suppress motion blurring in the images. Numerous other lighting configurations are within the scope of the invention including light sources that generate bright field illumination fields or transmit through the substrate of workpiece 10 to backlight features to be inspected.

Inspection performance may be further enhanced by the acquisition of three dimensional image data. For example, electrical component polarity marks such as notches, chamfers, and dimples are three dimensional in nature. Acquisition of three dimensional solder paste deposit image data enables measurement of critical height and volume parameters. Further, three dimensional image data can improve segmentation and identification of small features with height relative to the nearly flat substrate.

Three dimensional information such as the profile of a solder paste deposit may be measured using well known laser triangulation, phase profilometry, or moiré methods, for example. U.S. Pat. No. 6,577,405 (Kranz, et al) assigned to the assignee of the present invention describes a representative three dimensional imaging system. Stereo vision based systems are also capable of generating high speed three dimensional image data.

To acquire high speed two and three dimensional image data to meet printed circuit board inspection requirements, multiple camera arrays may be arranged in an angled, stereo configuration with overlapping camera array fields of view. The circuit board can then be moved in a nonstop fashion with respect to the camera arrays. Multiple, strobed illumination fields effectively “freeze” the image of the circuit to suppress motion blurring.

Application inspection program 71 computes three dimensional image data by known stereo methods using the disparity or offset of image features between the image data from the angled camera arrays arranged in a stereo configuration.

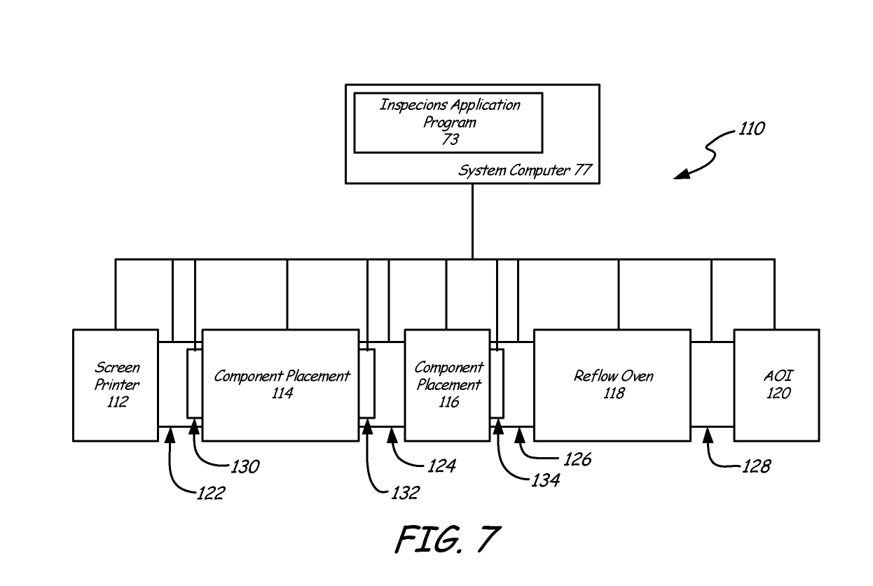

FIG. 7 is a block diagram of example automated printed circuit board assembly line 110 that includes an inspection system in accordance with an embodiment of the present invention. Solder paste screen printer 112 prints solder deposits in circuit board 10. A first, high throughput, component placement machine 114 places a number of electrical components on printed circuit board 10. Automated surface mount technology (SMT) assembly lines are often configured with one or more high speed “chip shooter” component placement machines that are optimized to place smaller components such as chip resistors and capacitors at high throughput rates. A second component placement machine 116 is illustrated and is often configured to place a wider range of component styles and sizes, albeit at slower throughput rates. For example, component placement machine 116 may place electrical connectors, ball grid array (BGA) components, flip chip components, quad flat pack (QFP) components, as well as smaller passive electrical components on circuit board 10. Reflow oven 118 melts the solder paste deposits to create mechanical attachment and electrical connection of the components to circuit board 10. Automated optical inspection system 120 provides final inspection of circuit board 10. Conveyors 122, 124, 126, and 128 transport circuit boards between various automated assembly machines in assembly line 110. As used herein a conveyor is intended to mean one or more automatic transport systems that move a workpiece or substrate from one location to another without human assistance. Moreover a conveyor may include an input buffer where workpieces can aggregate prior to an assembly operation. Thus, while a single conveyor 122 is shown coupling screen printer 112 to placement machine 114, such illustration is for clarity since conveyor 122 may include a number of automated system and/or buffers that operate to autonomously carry workpieces from the outlet of screen printer 112 to the inlet of placement machine 114.

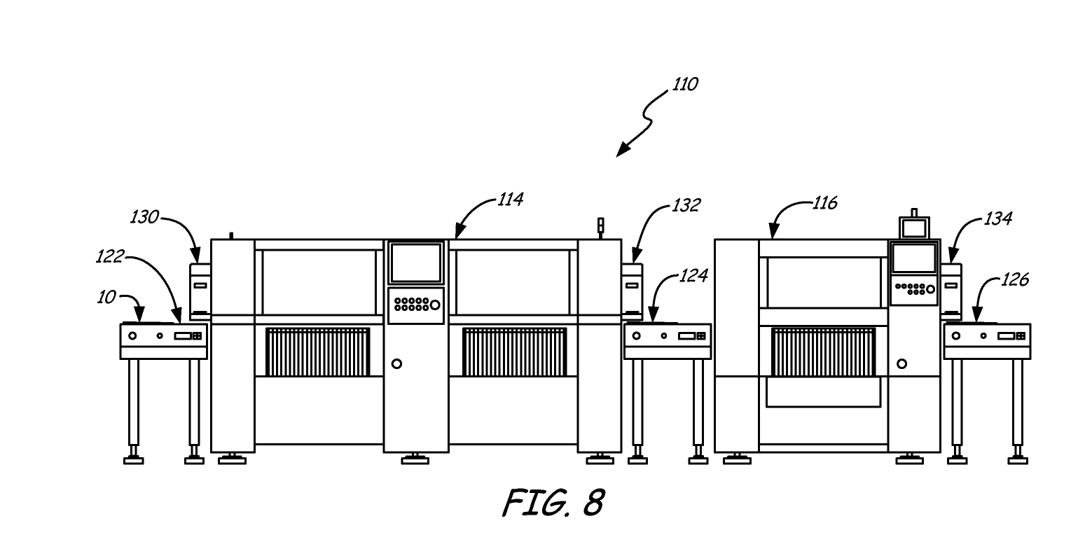

FIG. 8 is a front elevation view of a portion of assembly line 110. In a preferred embodiment, optical inspection sensors 130, 132, and 134 are configured similarly to optical inspection sensor 94 shown in FIG. 1. Computer 77 communicates with the equipment in assembly line 110 and inspection application program 73 computes inspection results using the two-dimensional images acquired by optical inspection sensors 130, 132, and 134. Inspection program 73 may also use three dimensional image data to enhance inspection results when optical inspection sensors 130, 132, and 134 are configured to provide stereo or other three dimensional image data. The optional/additional three dimensional image data can be provided for the entire circuit board or selected regions. Inspection sensors 130, 132, and 134 may be situated in close proximity to component placement machines 114 and 116 due to their compact form factors and may be integrated or “embedded” inside the component placement machines. By utilizing multiple optical inspection sensors that are distributed throughout the assembly process, the inspection performance can be improved and the initial programming of the inspection system can be simplified. Inputs to inspection program 73 include fiducial reference indicator locations, and component type, size, location, and polarity which information is known and available from component placement machines 114 and 116. Additional information such as component reference designators, the bar code number of circuit board 10, as well as the component feeder number, head number, and nozzle used for a particular component placement are also available from the component placement machines. Solder paste aperture data may be inputted into inspection program 73 from screen printer 112 or an external source.

Inspection application program 73 computes inspection results for solder paste printing such as print registration, area, percent coverage, and unintended bridging between adjacent solder pads. Height and volume may also be computed if three dimensional image data is available. After components are mounted on circuit board 10 by component placement machines 114 and 116, inspection program 73 computes inspection results to verify absence or presence of a component at a particular location on circuit board 10, whether the correct component was placed, the spatial offset of a component from its nominal design location, the spatial offset with respect to the solder paste print, and whether a component was mounted with the correct polarity. Inspection program 73 also computes whether a stray component was inadvertently released onto circuit board 10 at an improper location such as where another component is to be mounted during a subsequent placement operation.

During the assembly process and after solder paste screen printing, conveyor 122 transports printed circuit board 10 into component placement machine 114 in a non-stop fashion while inspection sensor 130 acquires images of circuit board 10 with one or more illumination field types. These images are transmitted to computer 77 and are made available to inspection application program 73 where the solder paste deposits are identified and the solder paste inspection results are generated.

Referring back to FIG. 4, it can be seen that circuit board 10 is represented with two duplicate circuits 8 and 9. Circuit boards are often designed with several duplicate circuits which are singulated into individual circuits at a later step in the assembly process. It is common to have eight or more individual circuits on one circuit board 10. Prior to placing components onto circuit board 10, component placement machines 114 and 116 must search circuit board 10 for so-called “bad marks” or “skip marks”. These skip marks identify individual defective circuits for which no components will be placed. Prior art component placement machines read the skip marks using a fiducial, or board alignment camera. In this case, the fiducial camera is positioned over the location of a potential skip mark. This positioning operation may take 0.5 or more seconds per skip mark which may add 4 or more seconds to the placement cycle time for a circuit board with eight individual circuits, for example.

In a preferred embodiment, the images acquired by optical inspection sensors 130 are analyzed by inspection program 73 to detect the presence or absence of skip marks for individual circuits. Detected skip marks are communicated by inspection program 73 to component placement machine 114 and the time consuming steps of positioning and reading the skip marks with the fiducial camera are eliminated. In a similar fashion, images acquired by optical inspection sensor 130 may be analyzed by inspection program 73 to read the barcodes for circuit board 10 and individual circuits 8 and 9 and then communicated to component placement machine 114. This eliminates the expense of a dedicated barcode reader or the time consuming process of reading the barcodes with the fiducial camera.

Component placement machine 114 then places a portion of electrical components onto circuit board 10. When the assembly operation by component placement machine 114 is complete, conveyor 124 facilitates transport of circuit board 10 in a non-stop fashion while optical inspection sensor 132 acquires images of circuit board 10 with one or more illumination types. These images are transmitted to computer 77 and are made available to inspection program 73. Inspection program 73 computes inspection results for component presence/absence, correct component, spatial offset, and component polarity for components placed by placement machine 114. Barcode reading and skip mark detection may also be computed by inspection program 73 using the images acquired by optical inspection sensor 132 and the results communicated to component placement machine 116.

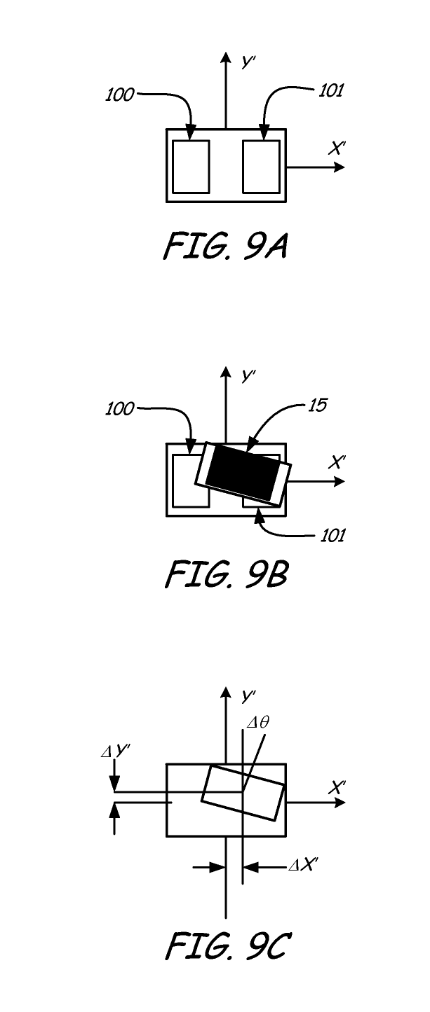

The component offset with respect to the solder paste deposits is also computed by inspection program 73 by using images captured before and after the component placement operation as explained with respect to FIGS. 9A-9C. FIG. 9A shows example solder paste deposits 100 and 101 on circuit board 10 identified by inspection program 73 using the images acquired with optical inspection sensor 130 before the assembly operation of component placement machine 114. Local coordinate axes X′, Y′ are shown that define the location of the solder paste deposits. FIG. 9B shows an example image of the same region of circuit board 10 that has been captured by optical inspection sensor 132 after the assembly operation of component placement machine 114. Component 15 was placed on circuit board 10 by component placement machine 114. Inspection program 73 registers the images captured before and after the component placement operation and then performs a difference operation on the registered images. Spatial offsets ΔX′, ΔY′, and Δθ′ for component 15 are computed by inspection program 73 using this difference image and the results are shown in FIG. 9C.

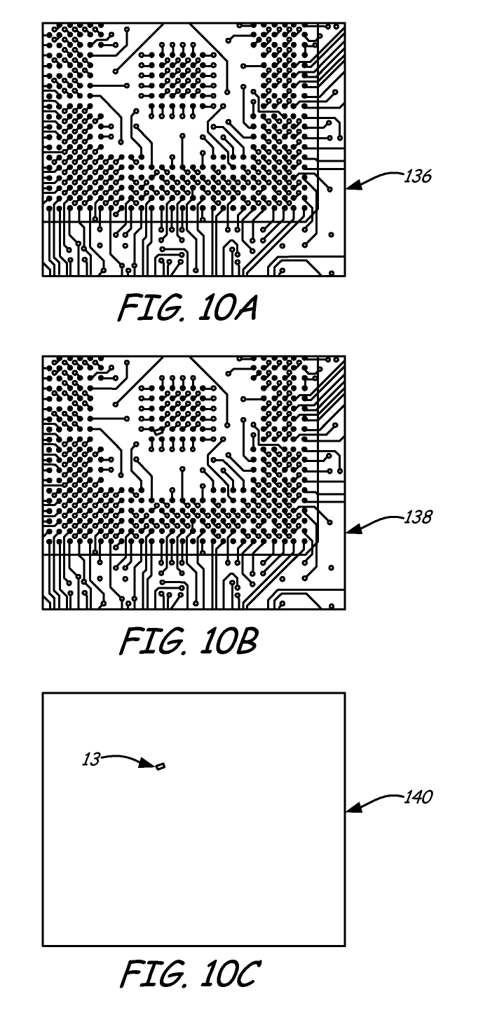

With the industry trend of electrical component sizes shrinking ever smaller, there is a risk of component placement machine 114 inadvertently releasing a component at an improper location on circuit board 10. For example, if this so-called stray component was released onto the location where a subsequent ball grid array (BGA) component was to be mounted by component placement machine 114, then this error would go undetected by AOI machine 120 since the stray component would not be visible. Circuit board 10 would not function as intended which may result in it being scrapped, or at least, the faulty BGA site would have to be diagnosed by other methods and reworked at significant cost. Inspection program 73 identifies stray components as explained with respect to FIGS. 10A-10C.

FIG. 10A shows example image 136 acquired by optical inspection sensor 130 in the region of where a BGA will be placed by component placement machine 116. FIG. 10B shows example image 138 acquired by optical inspection sensor 132 in the same region and where a stray component has been inadvertently released onto circuit board 10 by component placement machine 114. Inspection program registers images 136 and 138 and computes the difference image 140 shown in FIG. 10C. Since no components are intended to be placed in this region by placement machine 114, the presence of component in image 140 is an indication of a stray component. The assembly process may then be halted before additional components are added to circuit board 10 and additional expense incurred. Acquiring images 136 and 138 before and after an assembly step simplifies the initial programming of inspection program 73 since the difference image segments the stray component from numerous other valid features.

When the assembly operation by component placement machine 116 is complete, conveyor 126 facilitates transport of circuit board 10 in a non-stop fashion while optical inspection sensor 134 acquires images of circuit board 10 with one or more illumination types. These images are transmitted to computer 77 and are made available to inspection program 73. Inspection program 73 then computes inspection results for presence/absence, correct component, spatial offset, polarity, and offset with respect to the solder paste deposits for the remaining portion of components placed onto circuit board 10 by placement machine 116.

AOI machine 120 computes results such as verifying component presence/absence, location, polarity, and proper solder joint fillets after the solder has been reflowed by oven 118. However, AOI machine 120 cannot identify stray components at BGA or other larger component sites since they are no longer visible. When AOI machine 120 does detect an error, it is often difficult to determine the root cause of an assembly error at that stage in the assembly process. To facilitate improved root cause failure analysis, inspection program 73 can provide images of circuit board 10 to the defect review subsystem of AOI machine 120 that were captured by optical inspection sensors 130, 132, and 134 at the various stages of the assembly process and in the region of the defect identified by AOI machine 120. These images help narrow the list of potential assembly error sources and speed up root cause failure analysis.

Although the present invention has been described with reference to preferred embodiments, workers skilled in the art will recognize that changes may be made in form and detail without departing from the spirit and scope of the invention.

What is claimed is:

1. An electronics assembly system comprising:
an optical inspection sensor including:
an array of cameras configured to acquire image data relative to a workpiece that moves relative to the array of cameras in a non-stop fashion;
an illumination system disposed to provide a pulse of illumination when the array of cameras acquires the image data; and
wherein an least some image data includes data regarding a skip mark on the workpiece;
a component placement machine configured to receive the data regarding the skip mark and to selectively place components on the workpiece based on the data.

2. The electronics assembly system of claim 1, and further comprising a processor configured to receive the image data and provide an indication regarding the presence of the skip mark to the electronics assembly machine.

3. An optical inspection sensor comprising:
an array of cameras configured to acquire image data relative to a workpiece that moves relative to the camera in a first dimension;
wherein the array of cameras has an effective field of view that encompasses the entire workpiece in a dimension transverse to the first dimension.
an illumination system disposed to provide a pulse of illumination when the array of cameras acquires the image data; and
a processor configured to process the image data to identify and read a barcode on the workpiece.

4. The optical inspection sensor of claim 3, wherein the barcode is read by the sensor and information is provided by the sensor to a component placement machine based on the barcode.
